(19) United States
(12) Patent Application Publication
(10) Pub. No.: US 2006/0294388 A1
(43) Pub. Date: Dec. 28, 2006

(54) Method and system for enhancing user security and session persistence

(75) Inventors: Subil M. Abraham, Plano, TX (US); Tam M. Cao, Trophy Club, TX (US); Jason A. Gonzalez, Dallas, TX (US); Adam A. Nemati, Carrollton, TX (US); Mathews Thomas, Flower Mound, TX (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/158,609

(22) Filed: Jun. 22, 2005

(51) Int. Cl. H04L 9/00

(52) U.S. Cl. 713/182

(57) ABSTRACT

A system (10) and method (100) for enhancing security and session persistence can include the steps of authenticating (102) a user within a proximity of a first client device (19), sending (104) authentication data from a wireless scanning device (14) to a security server (16), and initiating (108) a client session at the first client device. Note, authentication data will be sent (106) from the security server to the application server. The method can further automatically log off (110) the user upon leaving the proximity and save the client session at an application server and further automatically authenticate and log-on (114) the user to the client session when entering a proximity of at least one among the first or a second client device. The method can detect (112) the presence of the user using an RFID scanner that detects an RFID tag from a badge held by the user.

### BACKGROUND OF THE INVENTION

1. Technical Field

This invention relates to the field of computer security, and more particularly, to a method and system for securing computer systems in a public environment.

2. Description of the Related Art

Display devices are often shared by employees in a given organization. Sharing of displays or terminals is quite a common practice in the retail environment where store employees have to use a common terminal to look at price information, inventory or current promotions. A given number of devices can be shared by many employees and a given employee may have to use multiple devices to perform effectively within the store. For example, the monitor available in the electronics department may be shared by all the employees in the electronics department. An employee in the electronics department may also work in the music department so this employee may need to use the monitors in both locations. Unfortunately, such existing systems not only require the manual logging on and off from separate terminals, but they also create security problems when an employee fails to log off and leaves a monitor unattended for a period of time.

### SUMMARY OF THE INVENTION

Embodiments in accordance with embodiments of the invention can include a new method and system that enables users of a networked system with secure access based on their security credentials and location to protected resources within an enterprise without necessarily having user physical intervention (e.g., keying in user ID/Password). The method and system can also track and maintain sessions and access information for subsequent requests without challenging the users to login and logoff multiple times.

In a first embodiment in accordance with the invention, a method for enhancing security and session persistence on a networked computing system having at least two client devices can include the steps of authenticating a user within a proximity of a first client device using a wireless scanning device, sending authentication data from the wireless scanning device to a security server on the networked computing system, and initiating a client session at the first client device. The method can further automatically log off the user from the first client device upon leaving the proximity of the first client device and save the client session at an application server and further automatically authenticate and log-on the user to the client session when entering a proximity of at least one among the first client device and a second client device. Note, the second client device uses a wireless scanning device to send authentication data to the security server. The method can detect the presence of the user using a radio frequency identification (RFID) scanner that detects an RFID tag from a badge held by the user. Further note, authentication data can be sent from the security server to the application server

In a second embodiment in accordance with the invention, a networked computing system having enhanced security and session persistence can include a radio frequency identification device containing an RFID tag carried by an authorized user of the networked computing system, a radio frequency scanner for detecting the RFID tag within a predetermined proximity of the radio frequency scanner, and a security server coupled to the radio frequency scanner, where the radio frequency scanner sends a user's information to the security server for authentication once the RFID tag is detected within the predetermined proximity and sends a request to close a client session once the RFID tag is no longer detected within the predetermined proximity. The system further includes a client device coupled to the security server and programmed to function in accordance with access instructions from the security server, and an application server coupled to the security server, where the application server provides for rendering an appropriate page at the client device based on a user profile and a user location while maintaining, closing, storing and retrieving the client session as the RFID tag moves from one client device to another within the networked computing system.

Note, the system can automatically authenticate the authorized user within the predetermined proximity of the radio frequency scanner by sending authentication data from the radio frequency scanner to the security server on the networked computing system and initiates a client session at a first client device. The system can automatically log off the first client device upon leaving the proximity of the first client device and saves the client session at the application server. The system can automatically authenticate and log on the user to the client session when entering a proximity of at least one among the first client device and a second client device. Note, when entering the proximity of the second client device, the second client uses another radio frequency scanner to send authentication data to the security server. The system can also be programmed to send authentication data from the security server to the application server, to retrieve the client session and a user profile to determine information to be displayed to the user once the user is within proximity of a client device, to detect the absence of a user after a predetermined time of no input received at the client device, to notify the security server that the user is no longer at the client device, to notify the application server (by the security server) to store the client session, and to send (by the security server) a logoff page to a browser on the client device to prevent access by another user using a previous user's credentials. Note, the client device can include a browser application for interacting with applications from the application server.

In other aspects of the invention, a computer program having a plurality of code sections executable by a machine for causing the machine to perform certain steps is described. The steps can generally include the steps outlined in the first and second embodiments described above.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is an illustration showing a user authenticated using a scanner in accordance with an embodiment of the present invention.

FIG. 2 is an illustration showing a user moving away from a scanner having their session preserved in accordance with an embodiment of the present invention.

FIG. 3 is a flow chart illustrating a method of enhancing security and session persistence on a networked computing system in accordance with an embodiment of the present invention.

### DETAILED DESCRIPTION OF THE INVENTION

A networked system as described above can introduce two unique problems that hinder employee effectiveness. The first problem involves security and the fact that most systems require a user to log in to access data. If the employee fails to log off when they are done, there is a danger that another employee may use the system using the previous employee's credentials or worse yet a roaming customer near the area where the employee was working could attempt to access the system while the employee is away from the client device or terminal. There are several techniques currently in place to prevent such security breaches, but they are not very effective. One option is to lock the system through some screen saver type of program if there is inactivity on the system. The problem with this approach is that the screen saver kicks off the user too soon or too late. Ideally, such a program would kick off the moment the employee moves away from the client device, but such a solution does not currently exist. In addition, the screen saver program might lock out users from using the system which is not necessarily compatible in an environment where devices are shared by different users.

The second problem encountered in a networked system as described above is session persistence. When a user moves from one client device to another (particularly on another system not sharing a server), a separate log in is required and the user will have to start a previous activity over again. This process can be time consuming and often discourages the employee from using the other client device. In the ideal case, the user moving between devices would like to ensure that session details are saved and information relevant to where the device is located is displayed.

Thus, embodiments in accordance with the present invention can provide users of the system with secure access, based on their security credentials and location, to the protected resources within the enterprise without user physical intervention (e.g., keying in user ID/Password). The system can also track and maintain sessions and access information for subsequent requests without challenging the users to login and logoff multiple times.

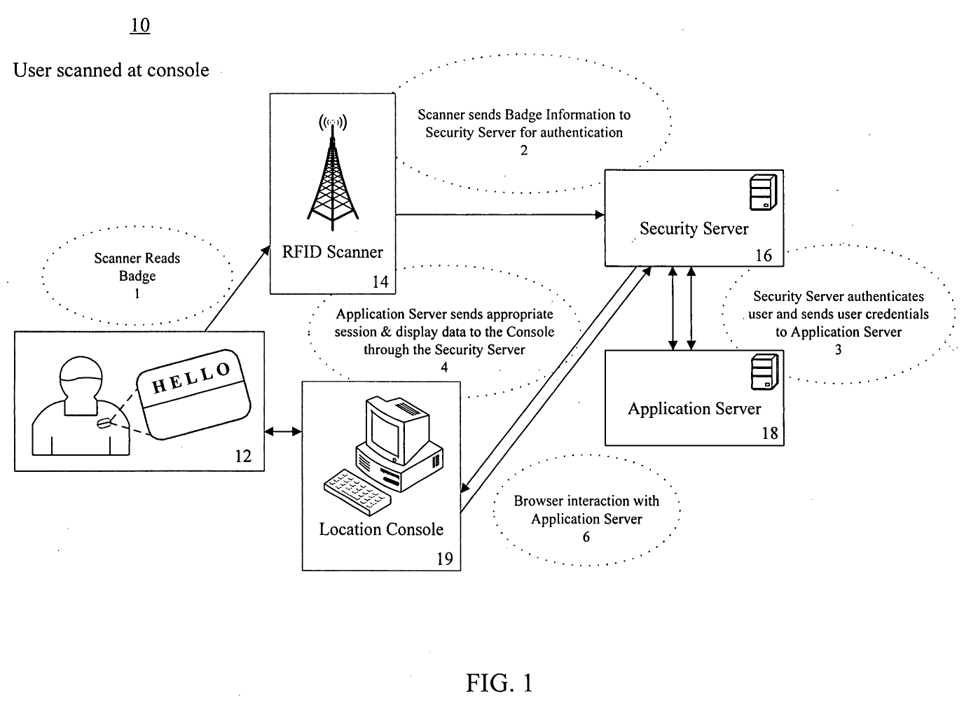

Referring to a networked system 10 as shown in FIG. 1, information (user credential and the location information) extracted from device such as a user badge 12 is gathered by an RFID scanner 14 that can feed in real time to an enterprise security server 16 having an enterprise security manager (for example, IBM Tivoli Access Manager for e-business). Upon successful user authentication, access to the protected resource such as an application server 18 is granted and an appropriate page is pushed onto a display console or client device 19 identified by the RFID scanner 14 (a unique capability). Access information is then cached by the security manager at the security server 16 for subsequent access requests by the user.

The user movement from one location to another can be tracked, periodically, by the RFID scanners (14) and fed real time to the security manager (16) and then to the application server (18) as explained above. Hence, user subsequent request from a different location is recognized by the system and an appropriate page based on the user profile and location is rendered on the client device 19. For example, when a sales associate moves from a console in the electronic department to a console in the music department, the application server 18 will send a page displaying available inventory in the music department, even though he/she previously viewing information related to electronics sold by the vendor on a console located in the electronics department. In addition, the session information is also propagated to the new console or client terminal so that the sales associate can continue with a previous transaction.

More specifically, a networked system 10 as shown in FIG. 1 can include the badge ID 12 which can be worn by the user and contains an RFID tag which stores the user authentication/authorization information that grants access to the enterprise protected resource (such as the application server 18). The badge ID 12 can be scanned and monitored by the RFID Scanners 14 installed in various scanning locations within an enterprise. The scanner 14 can be mounted near a location console or client terminal 19. The RFID Scanner 14 can be programmed to constantly scan for RFID tags in a scanning area which is typically within a predetermined proximity relatively close to the location console or client terminal 19. The RFID Scanner 14 can be programmed to send the user's badge information to the Security Server 16 for authentication once an RFID tag is detected in the scanning area. The RFID Scanner 14 can send a request to the Security Server 16 and the Security Server 16 notifies the application server 18 and the client terminal 19 to close the client terminal session when the current badge ID is no longer detected in the scanning area.

The location console or client terminal 19 can be resident at various locations in an enterprise like a TV area in an Electronics store or computer components areas in a storage room. The client terminal 19 can display a page based on the console location or an existing session maintained by the Application server 18 of the user. The client terminal 19 will close (or log off) the current session or save the session for future access based on a configuration parameters programmed in the Application Server 18 when the RFID Scanner 14 detects that the user is no longer in the scanning area. The Security Server 16 is responsible for user authentication, authorization and access control while the Application Server 18 is responsible for rendering an appropriate page based on the user location and profile. The Application Server 18 is also responsible for maintaining the current session information while the user is working in the scanning area and saving the current user session when the user is no longer in the scanning area.

Operationally, the networked system 10 can function in one scenario as follows: 1) The user moves within the location console or client terminal 19 and the RFID scanner 14 detects the presence of the user by detecting the badge ID 12 on the user. The RFID scanner 14 reads the information from badge on the user. The badge ID 12 contains an RFID tag that emits the user credentials. 2) The RFID scanner 14 sends the credentials to the security server 16. 3) The security server 16 authenticates the user into the system 10 and sends the information to that application server 18. 4) The application server 18 retrieves a user's previous session if one exists and user profile to determine what page should be displayed. This information (from the user's previous session and/or user profile) is sent to a browser at the client terminal 19 and the user can see a personalized page. 5) The user interacts with the client terminal or console 19 in a traditional manner, and 6) the user interacts via a browser at the client terminal 19 with the application server 18 in the traditional manner.

Note, the flow illustrated and described with respect to FIG. 1 is different from traditional web based systems. A browser traditionally sends the credentials to the security server which then communicates to the application server. Instead, in accordance with this embodiment of the present invention, the user credentials are obtained from a source (RFID scanner 14) that is completely separate from the browser. This is unique and enables the application server to start getting input from a variety of sources besides the browser at a client terminal and to aggregate the output to return to the browser or the different input points. Further note that session information is also stored and maintained as the user moves around.

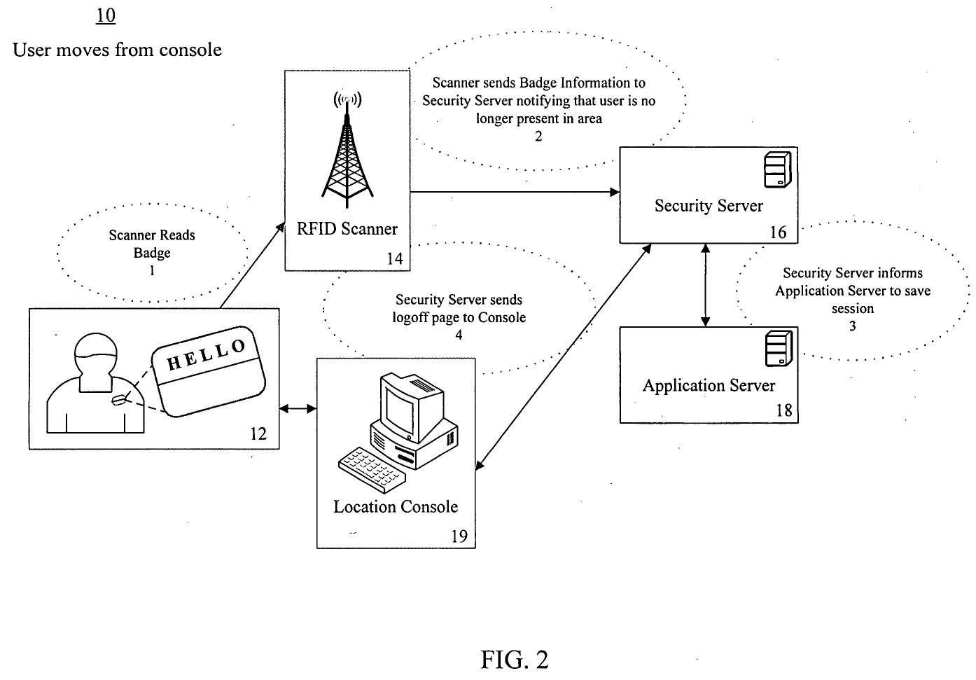

Referring to FIG. 2, a flow diagram shows how system 10 operates when a user move away from a client terminal 19. 1) As the user moves away from the client terminal 19, an RFID scanner 14 can detect the absence of the user. 2) The RFID scanner can notify the security server 16 that the user is no longer in the location console area (near a predetermined proximity of the client terminal 19 and/or RFID scanner 14). 3) The security server 16 can then notify the application server 18 to store the session information. 4) The security server 16 can then send a log off page to the browser so that another user may not access the system 10 with the previous user's credentials.

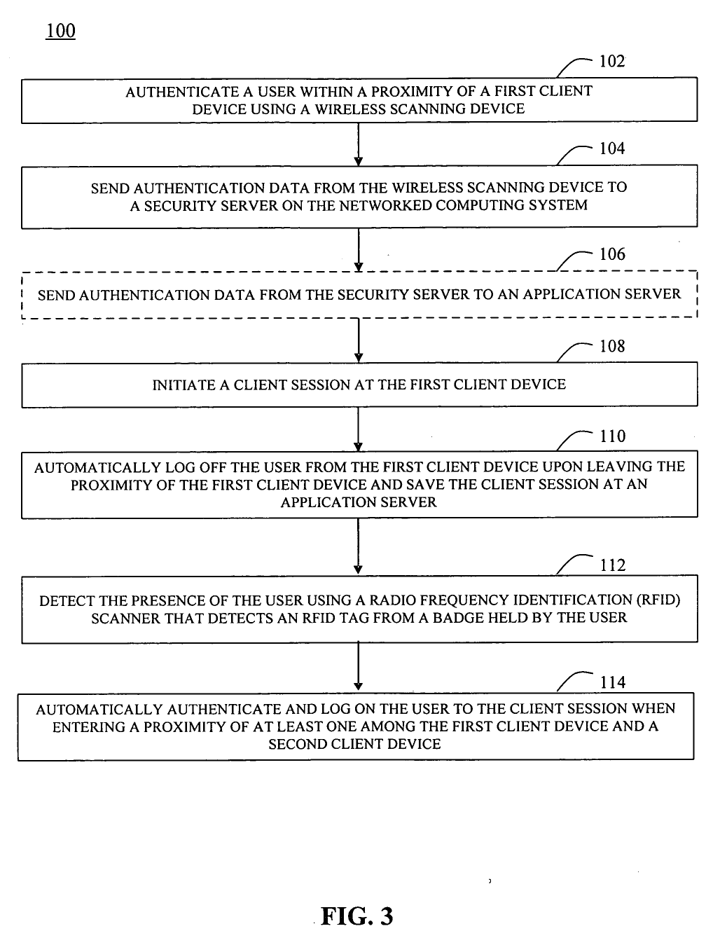

Referring to FIG. 3, a flow chart illustrating a method 100 for enhancing security and session persistence on a networked computing system having at least two client devices can include the step 102 of authenticating a user within a proximity of a first client device using a wireless scanning device, sending authentication data from the wireless scanning device to a security server on the networked computing system at step 104, and initiating at step 108 a client session at the first client device. Note, the second client uses a wireless scanning device to send authentication data to the security server. Also note, authentication data will be sent from the security server to the application server at step 106. The method 100 can further automatically log off the user from the first client device upon leaving the proximity of the first client device and save the client session at an application server at step 110. The method 100 can detect the presence of the user using a radio frequency identification (RFID) scanner that detects an RFID tag from a badge held by the user at step 112. The method 100 can also further automatically authenticate and log-on the user to the client session when entering a proximity of at least one among the first client device and a second client device at step 114.

It should be understood that the present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method enhancing security and session persistence on a networked computing system having at least two client devices, comprising the steps of:
authenticating a user within a proximity of a first client device using a wireless scanning device;
sending authentication data from the wireless scanning device to a security server on the networked computing system;
initiating a client session at the first client device;
automatically logging off the first client device upon leaving the proximity of the first client device and saving the client session at an application server; and
automatically authenticating and logging on the user to the client session when entering a proximity of at least one among the first client device and a second client device, wherein the second client uses a wireless scanning device to send authentication data to the security server.

2. The method of claim 1, wherein the method further comprises the step of detecting the presence of the user and wherein the wireless scanning device is a radio frequency identification scanner that detects an RFID tag from a badge held by the user.

3. The method of claim 1, wherein the method further comprises the step of sending authentication data from the security server to the application server.

4. The method of claim 3, wherein the further comprises the step of retrieving the client session and a user profile to determine information to be displayed to the user once the user is within proximity of a client device.

5. The method of claim 1, wherein the method further comprises the step of detecting the absence of a user after a predetermined time of no input received at the client device.

6. The method of claim 5, wherein the scanning device at the client device notifies the security server that the user is no longer at the client device and the security server notifies the application server to store the client session.

7. The method of claim 6, wherein the method further comprises the step of the security server sending a logoff page to a browser on the client device to prevent access by another user using a previous user's credentials.

8. A networked computing system having enhanced security and session persistence, comprising:
a radio frequency identification device containing an RFID tag carried by an authorized user of the networked computing system;
a radio frequency scanner for detecting the RFID tag within a predetermined proximity of the radio frequency scanner;
a security server coupled to the radio frequency scanner, wherein the radio frequency scanner sends a user's information to the security server for authentication once the RFID tag is detected within the predetermined proximity and sends a request to close a client session once the RFID tag is no longer detected within the predetermined proximity;
a client device coupled to the security server and programmed to function in accordance with access instructions from the security server; and
an application server coupled to the security server, wherein the application server provides for rendering an appropriate page at the client device based on a user profile and a user location while maintaining, closing, storing and retrieving the client session as the RFID tag moves from one client device to another within the networked computing system.

9. The networked computing system of claim 8, wherein the system automatically authenticates the authorized user within the predetermined proximity of the radio frequency scanner by sending authentication data from the radio, frequency scanner to the security server on the networked computing system and initiates a client session at a first client device.

10. The networked computing system of claim 9, wherein system automatically logs off the first client device upon leaving the proximity of the first client device and saves the client session at the application server.

11. The networked computing system of claim 8, wherein the system automatically authenticates and logs on the user to the client session when entering a proximity of at least one among the first client device and a second client device, wherein the second client uses another radio frequency scanner to send authentication data to the security server.

12. The networked computing system of claim 8, wherein the system is further programmed to send authentication data from the security server to the application server.

13. The networked computing system of claim 8, wherein the client device further comprises a browser application for interacting with applications from the application server.

14. The networked computing system of claim 8, wherein the system is further programmed to retrieve the client session and a user profile to determine information to be displayed to the user once the user is within proximity of a client device.

15. The networked computing system of claim 8, wherein the system is further programmed to detect the absence of a user after a predetermined time of no input received at the client device.

16. The networked computing system of claim 15, wherein the radio frequency scanner at the client device is programmed to notify the security server that the user is no longer at the client device and the security server notifies the application server to store the client session.

17. The networked computing system of claim 16, wherein the security server is further programmed to send a logoff page to a browser on the client device to prevent access by another user using a previous user's credentials.

18. A machine-readable storage, having stored thereon a computer program having a plurality of code sections executable by a machine for causing the machine to perform the steps of:
authenticating a user within a proximity of a first client device using a wireless scanning device;
sending authentication data from the wireless scanning device to a security server on the networked computing system;
initiating a client session at the first client device;
automatically logging off the first client device upon leaving the proximity of the first client device and saving the client session at an application server; and
automatically authenticating and logging on the user to the client session when entering a proximity of at least one among the first client device and a second client device, wherein the second client uses a wireless scanning device to send authentication data to the security server.

19. The machine readable storage of claim 18, wherein the computer program further comprises code sections for detecting the presence of the user by detecting an RFID tag from a badge held by the user.

20. The machine readable storage of claim 18, wherein the computer program further comprises code sections for detecting the absence of a user after a predetermined time of no input received at the client device, notifying the security server by the wireless scanning device that the user is no longer at the client device, notifying the application server by the security server to store the client session, and sending a logoff page by the security server to a browser on the client device to prevent access by another user using a previous user's credentials.
